(19) United States
(12) Patent Application Publication
(10) Pub. No.: US 2009/0004443 A1
(43) Pub. Date: Jan. 1, 2009

(54) CHAIR MAT

(76) Inventor: Thomas J. Nelson, Belton, TX (US)

Correspondence Address: WELSH & FLAXMAN LLC, 2000 DUKE STREET, SUITE 100, ALEXANDRIA, VA, 22314, US

(21) Appl. No.: 12/164,840

(22) Filed: Jun. 30, 2008

Related U.S. Application Data
(60) Provisional application No. 60/929,480, filed on Jun. 29, 2007.

(51) Int. Cl. B32B 5/00; B32B 9/04; B32B 29/00

(52) U.S. Cl. 428/195.1; 428/704; 428/537.5; 428/220

(57) ABSTRACT

A chair mat includes a first decorative layer, the first decorative layer being composed of melamine-formaldehyde impregnated decorative sheet. The chair mat also includes a central core layer including a top first surface and a bottom second surface, the central core layer being composed of at least one resin impregnated sheet. The first decorative layer is coupled to the top first surface of the central core layer. The chair mat also includes a second decorative layer coupled to the bottom second surface of the central core layer, the second decorative layer being composed of a melamine-formaldehyde impregnated decorative sheet.

### CROSS REFERENCE TO RELATE APPLICATION

The application claims the benefit of U.S. Provisional Patent Application Ser. No. 60/929,480, entitled “CHAIR MAT”, filed Jun. 29, 2007.

### BACKGROUND OF THE INVENTION

1. Field of the Invention

The invention relates to a chair mat. In particular, the invention relates to a chair mat composed of an engineered, resin impregnated laminate including opposed decorative surfaces of melamine-formaldehyde impregnated decorative sheets with a core layer of phenolic resin impregnated Kraft paper.

2. Description of the Related Art

Chair mats are common products found in both commercial office locations and home office locations. They provide protection to the underlying carpeting or flooring surface, while also providing a flat support surface upon which one may readily move a chair supported thereon. However, and as anyone who has worked within an office is certainly aware, chair mats are limited in their durability and aesthetics.

The most common type of chair mat is molded from a piece of pliable plastic to include a relatively flat upper surface and a lower surface with a series of downwardly extending nubs. In view of the pliable nature of these chair mats, it is necessary that they be utilized on a supporting surface which provides ample support for the chair mat. Where the chair mat is placed upon a cushioned, carpeted surface, the floor mat will consistently flex in a manner causing exaggerated cracking of the plastic of the floor mat. With this flexing also comes limited, or encumbered, movement of the chair as it is rolled upon the floor mat.

In addition to the requirement that these pliable floor mats be placed upon relatively hard supporting surfaces (for example, commercial grade carpeting bound to a hard sub floor, hardwood floors or bare concrete surfaces), these plastic chair mats will readily crack over time, negatively affecting their appearance and necessitating replacement thereof. Since the underside of the floor mat is provided with nubs and not a flat surface similar to the top surface, once the top surface is destroyed, the entire floor mat must be replaced.

Other chair mats are known that are made of more durable materials, for example, wood. However, these chair mats are relatively expensive and are generally thicker than is truly desirable.

With the foregoing in mind, an improved floor mat is provided in accordance with the present invention.

### SUMMARY OF THE INVENTION

It is, therefore, an object of the present invention to provide a chair mat including a first decorative layer, the first decorative layer being composed of melamine-formaldehyde impregnated decorative sheet. The chair mat also includes a central core layer including a top first surface and a bottom second surface, the central core layer being composed of at least one resin impregnated sheet. The first decorative layer is coupled to the top first surface of the central core layer. The chair mat also includes a second decorative layer coupled to the bottom second surface of the central core layer, the second decorative layer being composed of a melamine-formaldehyde impregnated decorative sheet.

It is also an object of the present invention to provide a chair mat including a large rectangular area with a lip portion extending therefrom.

It is also another object of the present invention to provide a chair mat wherein the first decorative layer is alpha-cellulose decorative paper and the second decorative layer is alpha-cellulose decorative paper.

It is also a further object of the present invention to provide a chair mat wherein the first decorative layer and the second decorative layer are impregnated with melamine-formaldehyde resin.

It is another object of the present invention to provide a chair mat wherein the central core layer is composed of a plurality of sheets of resin impregnated paper.

It is still another object of the present invention to provide a chair mat wherein the central core layer is impregnated with phenolic resin.

It is also an object of the present invention to provide a chair mat wherein the central core layer is composed of 10 to 12 sheets of kraft paper.

It is a further object of the present invention to provide a chair mat including first and second overlay layers respectively positioned on top of the first decorative layer and the second decorative layer.

It is still a further object of the present invention to provide a chair mat wherein the first overlay layer is composed of melamine-formaldehyde resin impregnated paper and the second overlay layer is composed of melamine-formaldehyde resin impregnated paper.

It is yet a further object of the present invention to provide a chair mat wherein the first overlay layer and the second overlay layer are treated with aluminum oxide.

It is also an object of the present invention to provide a chair mat wherein the aluminum oxide is selectively applied in a manner providing for desired wear and clarity characteristics.

It is also another object of the present invention to provide a chair mat wherein the first and second overlay layers are approximately 70% impregnated.

It is also a further object of the present invention to provide a chair mat wherein the chair mat is approximately ¼″ to approximately ⅜″ thick.

It is another object of the present invention to provide a chair mat wherein the chair mat is approximately 5/16″ thick.

It is a further object of the present invention to provide a chair mat wherein the chair mat is fire rated Class A.

It is also an object of the present invention to provide a chair mat wherein the first decorative layer and the second decorative layer are of the same aesthetic design.

It is still another object of the present invention to provide a chair mat wherein the first decorative layer and the second decorative layer are of different aesthetic designs.

It is also another object of the present invention to provide a chair mat wherein the chair mat is reversible for exposing either the first decorative layer or the second decorative layer.

It is a further object of the present invention to provide a chair mat wherein the chair mat is stain and chemical resistant.

It is also an object of the present invention to provide a chair mat wherein the chair mat is static dissipative.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a chair mat in accordance with the present invention.

FIG. 2 is a schematic showing the various layers of the present chair mat.

FIG. 3 is a detailed view of the various sheets making up the central core layer.

FIG. 4 is a perspective view of the present chair mat in accordance with an alternate embodiment.

FIG. 5 is a schematic showing the various layers of the chair mat shown with reference to FIG. 4.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

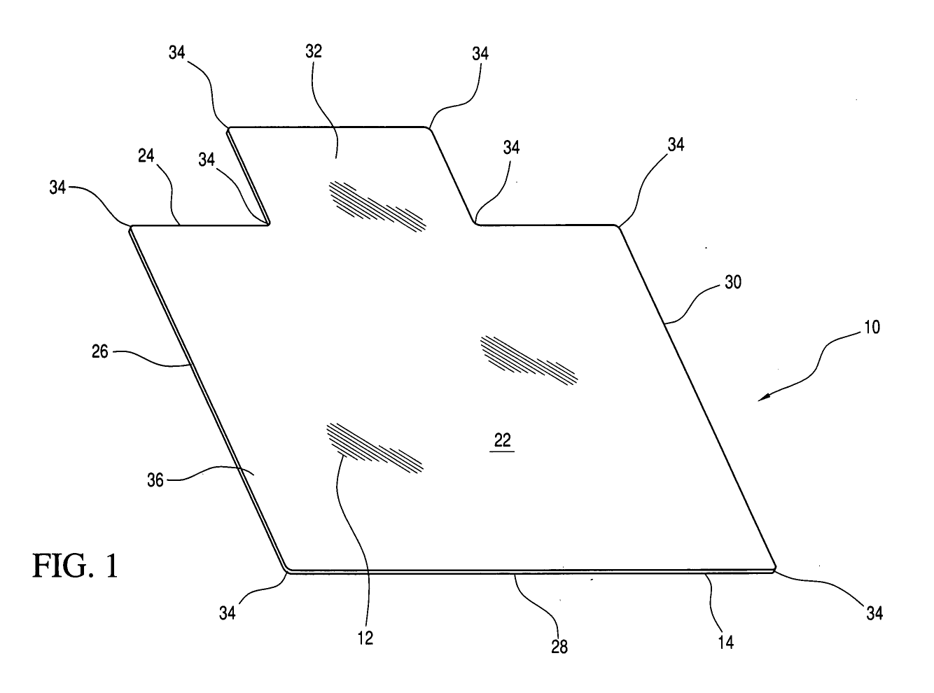

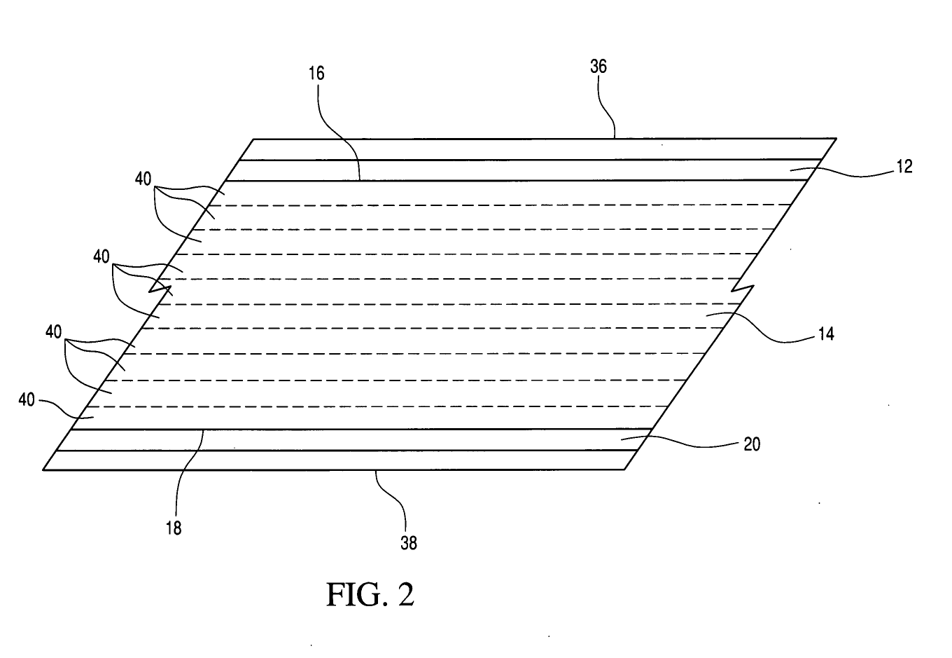

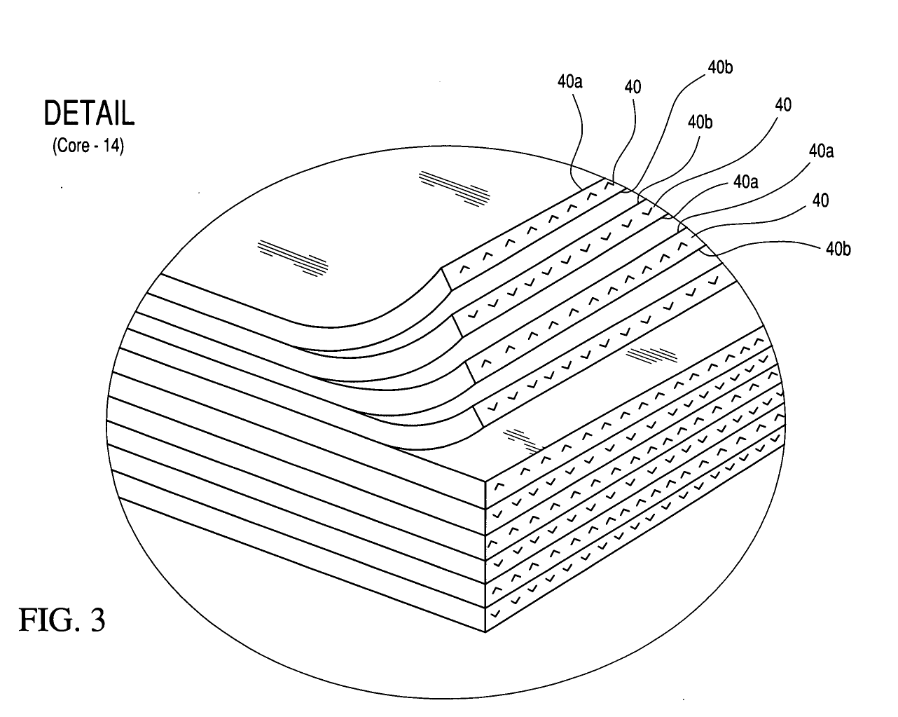

In accordance with the present invention, and with reference to FIGS. 1, 2 and 3, a chair mat 10 in accordance with the present invention is disclosed. The chair mat 10 includes a first decorative layer 12 (with the lead lines of FIG. 1 pointing to the aesthetics thereof as designated by the hatching therein) composed of a melamine-formaldehyde impregnated decorative sheet, a central core layer 14 having a top first surface 16 and a bottom second surface 18, and a second decorative layer 20 composed of a melamine-formaldehyde impregnated decorative sheet. The first decorative layer 12 is secured to the top first surface 16 of the central core layer 14 and the second decorative layer 20 is secured to the bottom second surface 18 of the central core layer 14.

As those skilled in the art will certainly appreciate, a chair mat 10 is formed for positioning behind a desk such that an individual may move his or her chair freely thereabout without unduly wearing upon the underlying flooring surface. As such, and in accordance with a preferred embodiment, the chair mat 10 includes a large square, or rectangular, area 22, upon which the chair itself sits during use. The large square, or rectangular, area 22 includes first, second, third and fourth sides 24, 26, 28, 30. A rectangular lip portion 32 extends from the first side 24 for positioning under the desk where the chair mat 10 is positioned. Depending upon the size of the desk and the room in which the desk is positioned, a chair mat 10 may vary in size from approximately 48″×48″ to approximately 60″×60″. While a shape is disclosed herein in accordance with a preferred embodiment of the present invention, those skilled in the art will appreciate the shape may be varied without departing from the spirit of the present invention.

In accordance with a preferred embodiment of the present invention, and based upon the materials used in the construction thereof, the corners 34 of the chair mat 10 are formed with a radius of curvature from approximately 0.5 inch to approximately 2 inches.

As to the first decorative layer 12 and the second decorative layer 20, they are similarly manufactured from high quality 65-160 grams/meters²basis weight, printed or non-printed, alpha-cellulose decorative paper treated or non-treated with an aqueous solution of melamine-formaldehyde resin. As those skilled in the art will appreciate the first decorative layer 12 and the second decorative layer 20 may be pretreated with melamine-formaldehyde resin or used untreated thereby allowing the resin from the first and second overlay layers 36, 38 to respectively pass therethrough and impregnate the first and second decorative layers 12, 20. The alpha-cellulose decorative paper that ultimately makes up the first and second decorative layers 12, 20 is cut into sheets for subsequent consolidation with the other layers of the present chair mat 10. The alpha-cellulose paper of the first and second decorative layers 12, 20 may include a solid color, a decorative design, or a photogravure reproduction of natural materials, such as, wood, marble, leather, etc. The decorative characteristics of the alpha-cellulose paper of the first and second decorative layers 12, 20 are revealed as the viewable decorative design upon completion of the present chair mat 10.

The central core layer 14 positioned between the first and second decorative layers 12, 20 is preferably composed of a plurality of sheets 40 of phenolic resin impregnated paper, although other materials may be used without departing from the spirit of the present invention. In accordance with a preferred embodiment of the present invention, the central core layer 14 includes a plurality of sheets of 120-299 grams/meters² dry phenolic resin impregnated Kraft paper. The Kraft paper is impregnated throughout with a substantially cured phenolic resin which has been partially cross-linked during the initial laminating step.

In accordance with a preferred embodiment, the central core layer 14 is composed of 10-12 sheets 40 of phenolic resin impregnated Kraft paper, depending upon the desired final thickness and the weight of the Kraft paper that is being used. Those skilled in the art will appreciate thinner sheets are better impregnated with the phenolic resin as they tend to saturate better, therefore, resulting in a more dense and strong composite after pressing. In addition, and in accordance with a preferred embodiment, the sheets 40 making up the central core layer 14 are flipped alternately so that top surfaces 40a of the sheets 40 face each other and the bottom surfaces 40b of the sheets 40 face each other. This balances the final product by ensuring the saturation levels of the paper sheets 40 are well balanced and do not cause warping in the resulting chair mat 10. As a result an even number of sheets should be used to properly balance the central core layer 14.

In accordance with a preferred embodiment, the sheets 40 making up the central core layer 14 are commonly 5-foot by 12-foot sheets and are flipped about an axis extending along the length (that is, the 12-foot dimension). The sheets 40 are flipped in this manner because it is known to those skilled in the art that Kraft paper sheets commonly used in the manufacture of laminates expand more in width than in length due to fiber orientation and paper construction. As a result, flipping of alternate sheets 40 in accordance with a preferred embodiment of the present invention results in a central core layer 14 which is highly balance by distributing imperfections in the treated Kraft paper among opposite sides of the resulting central core layer 14.

As briefly discussed above, it is contemplated the core layer may be composed of other materials without departing from the spirit of the present invention. For example, a plied fiberboard may be employed. Such a construction would preferably be composed of two thin fiberboard sheets glued together along their facing surfaces. Similarly, a core layer composed of cement board or a fiberglass composite could be utilized without departing from the spirit of the present invention. It is also contemplated the core layer may be composed of plywood, GRIDCORE (that is, an engineered sheet material composed of honeycomb shaped cavities adding structural stability to the material) or other engineered plastic materials. However, it is considered that each of these alternate core materials is burdened with the problem of aesthetically undesirable edge characteristics when the product is ultimately cut into its desired shaped.

In accordance with a preferred embodiment, first and second overlay layers 36, 38 are respectively positioned over both the first decorative layer 12 and the second decorative layer 20. The first and second overlay layers 36, 38 are preferably composed of a sheet of melamine-formaldehyde resin impregnated paper. The paper is preferably 60%-80% impregnated, more preferably approximately 70% impregnated. When the chair mat 10 is fully heated and pressed as described below, the first and second overlay layers 36, 38 become translucent, fully exposing both the first and second decorative layers 12, 20. In order to enhance the wear resistance of the first and second overlay layers 36, 38. They preferably contain aluminum oxide dispersed in a manner well known to those skilled in the art.

More particularly, the wear resistance properties of the present chair mat 10 are achieved by optimizing the application of aluminum oxide to the first and second overlay layers 36, 38. As those skilled in the art will appreciate, various techniques are employed in the application of aluminum oxide to the overlay layers.

In accordance with a first technique, the aluminum oxide is incorporated into the paper of the overlay layer prior to the application of melamine-formaldehyde resin thereto. This offers the advantage of providing greater clarity for viewing of the decorative layer, but, because the aluminum oxide is not actually upon the outer surface of the overlay layer, offers a low level of wear resistance. In accordance with a second technique, untreated paper is treated with aluminum oxide during the melamine-formaldehyde resin impregnation process by either spreading the aluminum oxide upon the paper after it has been drawn through the melamine-formaldehyde resin bath or incorporating the aluminum oxide directly into the melamine-formaldehyde resin bath. This technique provides for substantial wear resistance (that is, until the outer surface is worn through), but the application of the aluminum oxide to the outer surface of the overlay layer detracts from the clarity of the resulting laminate. A third technique takes advantage of both the first and second techniques by combining the techniques and utilizing a paper that is pretreated with aluminum oxide and is subsequently treated with additional aluminum oxide during the melamine-formaldehyde application.

In accordance with a preferred embodiment, aluminum oxide is applied to the first and second overlay layers 36, 38 of present chair mat 10 in a manner without adversely affecting clarity thereof while similarly improving the wear characteristics of the chair mat 10. With this in mind, aluminum oxide will be applied to the first and second overlay layers 36, 38 of the chair mat 10 by utilizing aluminum oxide finer (that is, approximately 25 micron aluminum oxide as opposed to 80 micron to 100 micron aluminum oxide commonly employed in the flooring industry) than that commonly utilized within the flooring industry, but utilizing less aluminum oxide than is commonly utilized within the flooring industry. In addition, and as those skilled in the art will certainly appreciate, the wear resistance of the chair mats 10 in accordance with the spirit of the present invention may be engineered to accommodate various needs and uses by simply adjusting the technique used in the application of the aluminum oxide to the overlay layer employed in the manufacture of the chair mat 10. As a result, chair mats 10 may be readily manufactured which are capable of offering wear resistance between approximately 400 and approximately 3,000 cycles NEMA.

By constructing the present chair mat 10 of a laminated structure that is balanced in a desirable manner (that is, substantially identical first and second decorative layers 12, 20 and substantially identical first and second overlay layers 36, 38 on opposite sides of a central core layer 14 composed of alternately flipped sheets of Kraft paper), the present chair mat 10 is not susceptible to warping or bending resulting from uneven forces being applied to both the top and bottom surfaces of the chair mat 10.

Once the first decorative layer 12 (that is, the first decorative paper sheet), the central core layer 14 and the second decorative layer 20 (that is, the second decorative paper sheet), as well as the first and second overlay layers 36, 38 are manufactured, a laminate lay-up is constructed. The laminate lay-up includes, in order of stacking, the first overlay layer 36, the first decorative layer 12, the central core layer (composed of 10-12 sheets of phenolic impregnated Kraft paper) 14, the second decorative layer 20 and the second overlay layer 38. The layers are stacked and placed between steel plates. The laminate lay-up stack is then subjected to temperatures in the range of 121° Celsius to 160° Celsius and pressures of approximately about 56.24 kilograms/cm² to approximately 112.48 kilograms/cm² for a time sufficient to consolidate the laminate and cure the resins (generally about twenty-five minutes to an hour). The pressure and heat force the resin in the paper sheets to flow, cure and consolidate the sheets into a unitary laminated mass. Generally, more than one laminate is formed at one time. Multiple laminates are formed by inserting a plurality of assembled sheets between press plates in a stack. Release sheets may be positioned between the assembled sheets to separate the various laminates stacked together. After consolidation, the release sheet allows the individual laminates to be separated.

Once the consolidated mass composed of the first overlay layer 36, the first decorative layer 12, the central core layer 14, the second decorative layer 20 and the second overlay layer 38 are formed, they are cut in a desired shape of a chair mat 10 and ready for usage. In particular, and in accordance with a preferred embodiment, the consolidated mass is cut into the form of a chair mat 10 utilizing conventional CNC (computer numerically controlled) machinery. As a result, a variety of chair mat shapes and sizes may be offered by simply adjusting the parameters input into the CNC machine. The geometries may fall anywhere within the 5′×12′ envelope contemplated for the manufacture of the consolidated mass sheets that are ultimately cut into the chair mat 10 of the present invention.

The present chair mat 10 provides an engineered laminated structure obviating many of the shortcomings of the prior art. First, given the rigidity of the laminated chair mat 10 of the present invention, it may be placed upon a variety of surfaces without worrying that the underlying surface is too cushioned. In addition, it will only be approximately ¼″ to ⅜″ thick, preferably approximately 5/16″ thick, and as such will not present a problem with people tripping thereover. In addition, the thickness of the chair mat may be readily varied by increasing or decreasing the number of sheets of Kraft paper employed in the central core layer 14 thereof.

The present chair mat 10 has also been engineered to provide a balanced structure inhibiting the undesirable warping or “rolling up” of edges of the chair mat 10. This is achieved by providing a central core layer 14 having identical decorative layers 12, 20/overlay layers 36, 38 applied on opposite sides thereof in an equal and balanced manner. As such, forces generated through the expansion or contraction of either side are balanced by a counter flexing on the opposite side. As a result, the chair mat 10 will remain flat regardless of which type of surface it is placed on.

As discussed above, the present chair mat 10 also provides decorations on both sides thereof by providing the same or different decorative sheets to the first and second decorative layers 12, 20 of the present chair mat 10. As such, a user can simply flip the chair mat 10 over when one side is worn or the user is tired of the aesthetic appearance of that side. As a result, the user may achieve two chair mats in the form of one. In accordance with a preferred embodiment of the present invention, designs such as, but not limited to, sports logos, university emblems, corporate logos, personal pictures, building maps, etc. may be incorporated into the decorative layers 12, 20 of the present chair mat 10.

The materials used in the construction of the present chair mat 10 also result in a chair mat 10 that may be fire rated as a Class A material because the resulting laminate structure is resistance to burning. In addition, the melamine-formaldehyde resin of the decorative layer and overlay layer is highly chemical resistance and stain resistant.

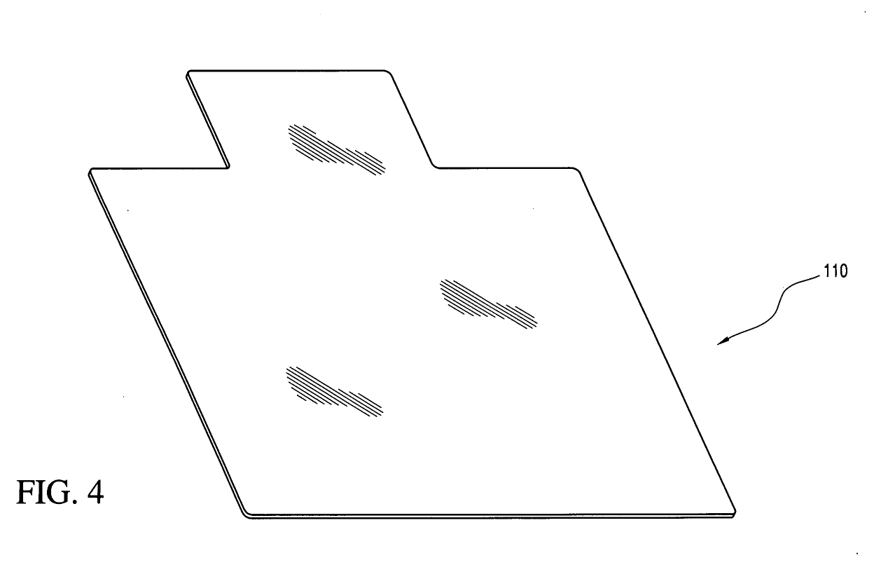

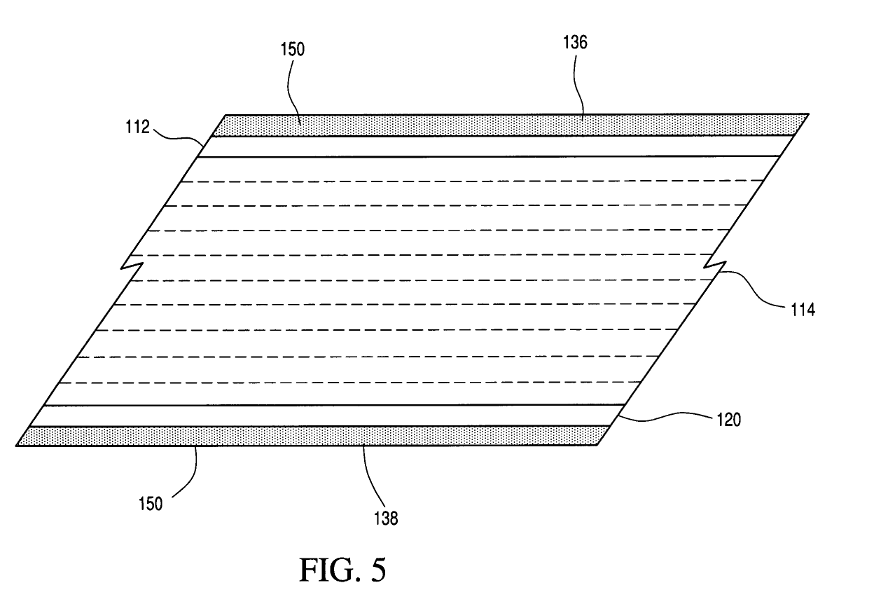

Referring to FIGS. 4 and 5, and in accordance with an alternate embodiment, the laminate chair mat 110 of the present invention may be formulated with static dissipative characteristics. As such, users of the present chair mat 110 will avoid problems associated with shock as he or she rolls his chair about the chair mat 110 in the environment of a synthetic carpet material. In accordance with a preferred embodiment, the static dissipative characteristics are imparted to the chair mat 110 by incorporating carbon fibers 150 into the paper sheets malting up the first and second overlay layers 136, 138. However, it is contemplated the carbon fibers may also be incorporated into the decorative layers 112, 120 or the core layer 114.

While the preferred embodiments have been shown and described, it will be understood that there is no intent to limit the invention by such disclosure, but rather, is intended to cover all modifications and alternate constructions falling within the spirit and scope of the invention.

1. A chair mat, comprising:
a first decorative layer, the first decorative layer being composed of a melamine-formaldehyde impregnated decorative sheet;
a central core layer including a top first surface and a bottom second surface, the central core layer being composed of at least one resin impregnated sheet, wherein the first decorative layer is coupled to the top first surface of the central core layer; and
a second decorative layer coupled to the bottom second surface of the central core layer, the second decorative layer being composed of a melamine-formaldehyde impregnated decorative sheet.

2. The chair mat according to claim 1, further including a large rectangular area with a lip portion extending therefrom.

3. The chair mat according to claim 1, wherein the first decorative layer is alpha-cellulose decorative paper and the second decorative layer is alpha-cellulose decorative paper.

4. The chair mat according to claim 3, wherein the first decorative layer and the second decorative layer are impregnated with melamine-formaldehyde resin.

5. The chair mat according to claim 1, wherein the central core layer is composed of a plurality of sheets of resin impregnated paper.

6. The chair mat according to claim 5, wherein the central core layer is impregnated with phenolic resin.

7. The chair mat according to claim 5, wherein the central core layer is composed of 10 to 12 sheets of Kraft paper.

8. The chair mat according to claim 1, further including first and second overlay layers respectively positioned on top of the first decorative layer and the second decorative layer.

9. The chair mat according to claim 8, wherein the first overlay layer is composed of melamine-formaldehyde resin impregnated paper and the second overlay layer is composed of melamine-formaldehyde resin impregnated paper.

10. The chair mat according to claim 9, wherein the first overlay layer and the second overlay layer are treated with aluminum oxide.

11. The chair mat according to claim 10, wherein the aluminum oxide is selectively applied in a manner providing for desired wear and clarity characteristics.

12. The chair mat according to claim 9, wherein the first and second overlay layers are approximately 70% impregnated.

13. The chair mat according to claim 1, wherein the chair mat is approximately ¼″ to approximately ⅜″ thick.

14. The chair mat according to claim 11, wherein the chair mat is approximately 5/16″ thick.

15. The chair mat according to claim 1, wherein the chair mat is fire rated Class A.

16. The chair mat according to claim 1, wherein the first decorative layer and the second decorative layer are of the same aesthetic design.

17. The chair mat according to claim 1, wherein the first decorative layer and the second decorative layer are of different aesthetic designs.

18. The chair mat according to claim 1, wherein the chair mat is reversible for exposing either the first decorative layer or the second decorative layer.

19. The chair mat according to claim 1, wherein the chair mat is stain and chemical resistant.

20. The chair mat according to claim 1, wherein it is static dissipative.
